(19) United States
(12) Patent Application Publication
(10) Pub. No.: US 2001/0002200 A1
(43) Pub. Date: May 31, 2001

(54) REMOVABLE LINERS FOR INDUCTIVE FURNACES

(75) Inventor: EARL K. STANLEY, NAPLES, FL (US)

Correspondence Address: Conrad J. Clark, Clark & Brody, 1750 K. Street NW, suite 600, Washington, DC, 20006, US

(73) Assignee: Conrad J. Clark

(21) Appl. No.: 08/747,763

(22) Filed: Nov. 13, 1996

Related U.S. Application Data
(60) Provisional application No. 60/006,553, filed on Nov. 13, 1995.

(51) Int. Cl. H05B 6/24

(52) U.S. Cl. 373/153; 373/143

(57) ABSTRACT

A liner for an induction furnace is capable of being removed intact or rotated. Removal allows the liner to be refurbished or replaced with a different liner. Rotation allows asymmetrical wear on the liner to be evened out by periodic rotation. The liner is preferably made of a composite material of inductively transparent fibers and inductively transparent inorganic cements.

### CROSS REFERENCE TO RELATED APPLICATION

This application corresponds to provisional application Ser. No. 60/006,553, filed Nov. 13, 1995.

### TECHNICAL FIELD

This invention relates to the art of induction furnaces. In particular, the invention, relates to removable and rotatable liners for induction furnaces.

### BACKGROUND

Induction furnaces are well known and generally include a cylindrical induction coil lined with a refractory material, a power supply, and apparatus for tilting the furnace to discharge molten metal. The lining is a refractory material that is applied directly to the induction coil in one or more layers.

A problem facing prior art induction furnaces is rapid deterioration of the refractory lining. The lining deteriorates by chemical reaction between the hot lining and air as the molten metal is poured out, by chemical attack from the slag or metal, or by physical damage during removal of the slag. The degradation due to air exposure is typically greatest in the region at the top of the lining and opposite the pour spout.

Replacement of a refractory lining may require as long as several days because the refractory lining must be cooled and dug out of the furnace, typically, with a jackhammer, and then the new refractory lining must be installed and allowed to cure. One method addressing the problem of replacing a lining is contained in U.S. Pat. No. 5,416,795 (Kaniuk). According to that suggestion a crucible assembly is provided comprising a crucible and crucible support. The crucible support is cast around the crucible to form the crucible assembly. The crucible assembly is capable of being removed from the induction coil, and a replacement unit may be installed. This system, however, does not permit reuse or refurbishment of the assembly, and it is discarded after its removal from the furnace.

Inductively transparent ladles for manufacture of metals are also known. For example, U.S. Pat. Nos. 4,921,222 and 5,039,345 (Mott) teach inductively transparent ladles made of inductively transparent glass fibers and inductively transparent inorganic cement forming a matrix for the fibers. These ladles are stand-alone structures that require no additional support and include elements such as trunions for allowing the ladles to be transported when full of molten metal and tilted for pouring the metal.

### SUMMARY OF THE INVENTION

In accordance with the invention, a removable, inductively-transparent liner is provided for an induction furnace of the type that includes an induction coil located above a furnace bottom. The novel liner of the invention may be used for virtually any type of induction furnace, including furnaces used for processing iron, copper, stainless steel, carbon steel, or aluminum.

The inductively transparent liner of the invention is preferably designed to fit within the induction coil of an existing furnace in such a manner that it may be moved with respect to the coil without harm to the liner. Thus, the outside dimensions of the liner are preferably slightly smaller than the inner dimensions of the coil whereby engagement between the liner and the coil is minimal. The liner is strong enough to support molten metal only when the liner is in the furnace but is not strong enough to transport molten metal by itself. Thus, when the liner is positioned in the furnace and engaging the bottom of the furnace, the liner will safely contain the molten metal without significant support from the coil structure. On the other hand, the liner is not strong enough to be removed safely from the furnace with a load of molten metal. This structure allows the liner to have only nominal or no contact with the sides of the furnace, i.e., the coil structure, and thereby to be released from the coil intact or rotated with respect to the coil for continued operation. The liner is secured to the furnace framework by known mechanical means, such as brackets, for normal operation and to allow it to be easily released from the framework by removal of the brackets.

Replacement liners may be constructed at a separate location, for example, by the winding technique shown in the noted Mott patents. When it is desired to install a new liner, the previous one is simply released, and the new one installed. Installation of a new liner may be desirable when the refractory lining in a first one is spent or when it is desired to use the furnace to melt a different metal or alloy that requires a different refractory or to avoid contamination. In either instance, installation of a new liner will be a simple matter. Additionally, the liner itself may be refurbished by removing the spent refractory lining and then installing a new one. This would be done away from the furnace causing no furnace downtime.

Periodic rotation of the liner allows wear or degradation of the refractory lining caused, for example by pouring or by oxidation of exposed areas, to be evened out. By thus spreading the degradation over the circumference of the refractory lining, the lifetime of the refractory lining is easily substantially increased. The amount and frequency of the rotation will be a function of specific circumstances. The inductively transparent liner is preferably made of a material including glass fibers and inorganic cements as taught in the noted Mott patents, to provide the necessary strength. The disclosure of these patents is hereby incorporated by reference. In the preferred embodiment, the material consists of the fibers and the cement to provide transparency to virtually all electromagnetic energy used in induction furnaces including frequencies above about 200 Hz. Also, a known refractory lining is provided to protect the liner and to insulate it from the temperatures of the molten metal. Alternatively, a pre-cast crucible is provided in lieu of the refractory lining. This crucible would be installed into the liner in a known manner with a backup refractory material placed between the liner and the crucible.

### BRIEF DESCRIPTION OF THE DRAWINGS

FIG. 1 is a vertical cross section of a known induction furnace having a removable inductively transparent liner in accordance with the invention therein.

FIG. 2 is a vertical cross section of a known induction furnace with a tilting mechanism and having an inductively transparent liner in accordance with the invention therein.

FIG. 3 shows an induction furnace as in FIG. 2 in the position where the metal is being poured.

### DETAILED DESCRIPTION OF THE PREFERRED EMBODIMENT

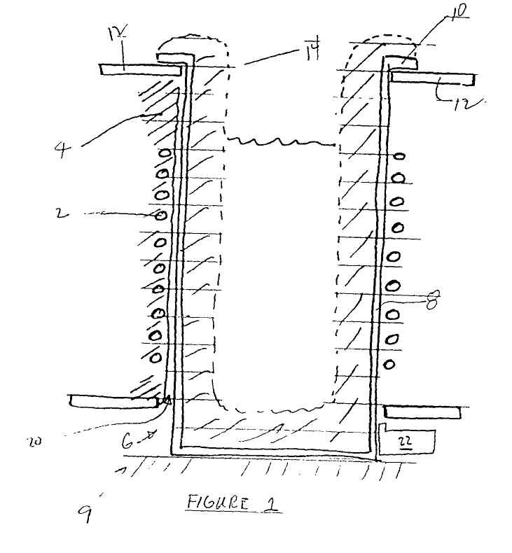

With reference to FIG. 1, an inductive furnace includes a coil 2 that is connected to a power supply (not shown) for generating electromagnetic fields as known in the art. The spaces between the coils are filled with a grout 4 for holding the coil elements in place. In accordance with the invention, a removable liner 6 is formed of a composite comprising substantially continuous glass fibers and inorganic cement.

The liner includes a lower cavity portion 8 for receiving materials for producing metals or metal alloys and a lip 10 for engaging a support 12. The liner may be secured to the support in any of several known ways. A refractory lining 14 is applied to the interior of the liner to protect the liner, the liner providing the majority of the structural strength required by the refractory lining to support the molten metal. It is noted in this connection, however, that the liner is not designed to be a stand-alone structure and requires the support of the bottom 9 of the furnace. Moreover, the liner is not designed to be carried with a full load of molten metal. Thus, the wall thickness of the liner may be substantially less than that of a ladle. The liner is capable of carrying frozen metal, however, because the walls as well as the bottom of the liner would support the metal.

Because the liner has strength adequate to support the refractory and the metal without contact with the coil, it may be desired to provide a small gap 20 between the liner and the coil. Further, it may be desired to force air through this gap with a fan 22 to provide cooling.

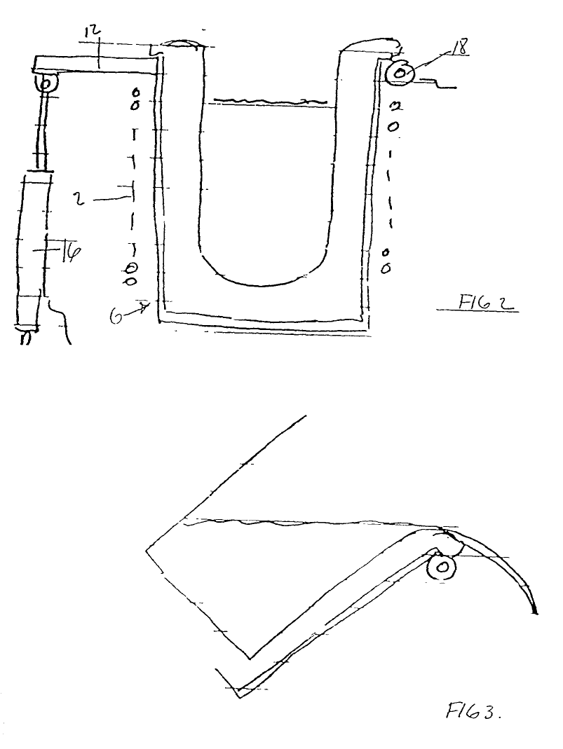

FIG. 2 shows a furnace having a hydraulic tilting mechanism 16, which engages the support 12 for tilting the furnace and liner about a pivot 18 for discharging the molten metals by pouring. The furnace is shown in a normal operating orientation in FIG. 2, and FIG. 3 illustrates the furnace in an orientation where the metal is discharged by pouring. It will be appreciated that the portion of the refractory lining not covered by metal is exposed to the air and is subject to chemical degradation during pouring.

In use, the liner 6 may be easily replaced by releasing the liner from the support 12 and lifting it away from the coil. There are many known devices for holding the liner to the support, such as mechanical brackets and these may be removed to allow the liner to be lifted out of the coil. The liner may then be replaced by a new liner, a refurbished liner, or by a different liner previously used for a different metal. Thus, the same furnace may be used for producing several kinds of metals without contamination among the metals.

In accordance with another aspect of the invention, the liner is rotated periodically by releasing the securing brackets, rotating the lining, and securing the brackets. This changes the location on the liner where the metal is poured out of the liner and changes the portions of the liner that are exposed to the atmosphere and the molten metal during pouring. This process spreads the wear on the refractory lining caused by pouring evenly about the interior of the refractory lining and thereby extends the life of the lining.

Modifications within the scope of the appended claims will be apparent to those of skill in the art.

I claim:

1. In an induction furnace having a furnace bottom, an induction coil located above said bottom, a liner in said induction coil for receiving metal, and means for tilting said liner for discharging said metal, the improvement wherein said liner is inductively transparent to electromagnetic energy for heating and stirring said metal, including frequencies above about 200 Hz and comprises an inductively transparent composite material of inductively transparent, substantially continuous fibers and inductively transparent inorganic cement binding said fibers together.

2. An induction furnace according to claim 1 wherein said liner has an outer surface that is adjacent said induction coil and spaced therefrom by an air gap.

3. An induction furnace according to claim 2 further comprising means for forcing air to flow in said gap.

4. An induction furnace according to claim 1 wherein said liner has an outer surface that is in contact with said induction coil.

5. Apparatus for containing metal in an induction furnace comprising an inductively transparent liner having side walls and a bottom wall for resting on a bottom of said furnace and for being received within an induction coil of said furnace, wherein the physical strength of said side walls and said bottom wall is such that said liner is capable of containing molten metal only when said liner is in said furnace.

6. Apparatus according to claim 5 wherein said side and bottom walls are made of inductively transparent fibers and inductively transparent inorganic cement.

7. Apparatus according to claim 5 or 6 wherein said liner is capable of containing solid or frozen metal and being removed from said furnace.

8. Apparatus according to claim 5 or 6 wherein said liner is capable of being rotated with respect to said induction coil.

9. Apparatus according to claim 5 or 6 wherein said liner is capable of being removed intact from said furnace after use and reused.

10. Apparatus according to claim 5 or 6 further comprising a refractory lining covering an interior surface of said liner.

11. A process for refining metal in an induction furnace of the type comprising an induction coil, a furnace bottom, and means for removing metal from said furnace, said process comprising the steps of placing an inductively-transparent liner in said induction coil, placing said metal in said liner, applying electric current to said coil to heat said metal, removing said metal, and removing said liner from said furnace intact.

12. A process according to claim 11 further comprising the step of refurbishing said liner to provide a refurbished liner and installing said refurbished liner in an induction furnace.

13. A process according to claim 11 wherein said liner is made of inductively transparent fibers in a matrix of inductively transparent inorganic cement.

14. A process according to claim 11 wherein each of said liner includes a refractory lining.

15. A process according to claim 12 wherein said step of refurbishing comprises replacing said refractory lining.

16. A process according to claim 11 further comprising the step of replacing said liner in said coil in a rotational orientation distinct from an initial rotational orientation.

17. A process for refining metal in an induction furnace of the type comprising an induction coil, a liner, a furnace bottom, and means for removing metal from said furnace by tilting said furnace to pour said metal from said furnace at a pouring location on said liner, said process comprising the steps of placing an inductively-transparent liner in said induction coil, placing said metal in said liner, applying electric current to said coil to heat said metal, removing said metal by pouring said metal out of said liner at said pouring location, and rotating said liner with respect to said means for removing to provide a new pouring location on said liner.

18. A process according to claim 17 wherein said liner is made of inductively transparent fibers in a matrix of inductively transparent inorganic cement.
